(19) United States
(12) Patent Application Publication
(10) Pub. No.: US 2025/0278567 A1
(43) Pub. Date: Sep. 4, 2025

(54) NATURAL LANGUAGE PROCESSING FOR NAMED ENTITY RECOGNITION ON SPEECH TRANSCRIPTION USING GROUND TRUTH TRANSCRIPTION FOR TRAINING

(71) Applicant: JPMorgan Chase Bank, N.A., New York, NY (US)

(72) Inventors: Harsh Saiprasad Deshpande, Santa Clara, CA (US); My Phung, Manhattan, NY (US); Ahmad Emami, New York, NY (US); Kanishk Singh, New York, NY (US)

(73) Assignee: JPMorgan Chase Bank, N.A., New York, NY (US)

(21) Appl. No.: 18/592,776

(22) Filed: Mar. 1, 2024

(51) Int. Cl. G06F 40/295; G06F 40/40

(52) U.S. Cl. CPC G06F 40/295; G06F 40/40

(57) ABSTRACT

Aspects of the subject disclosure may be directed to, for example, a method including receiving a first text input that represents entity description at an entity encoder, receiving a second text input that represents Automatic Speech Recognition (ASR) transcription at a text encoder, receiving a third text input that represents ground truth transcription at the text encoder, performing embeddings of the first text input, the second text input, and the third text input, training a natural language processing model, and generating a predicted entity output and a predicted non-entity output using the trained natural language processing model. Other embodiments are disclosed.

### FIELD OF THE DISCLOSURE

The subject disclosure relates to natural language processing systems and methods for performing an improved named entity recognition on speech transcription using a ground truth transcription for training.

### BACKGROUND

Spoken language understanding (SLU) system includes an automatic speech recognition (ASR) engine that converts speech signals into transcripts. The SLU system includes a natural language understanding (NLU) model to perform downstream analytics such as named entity recognition. The transcripts from the ASR engine may contain errors which may directly affect the NLU model.

### BRIEF DESCRIPTION OF THE DRAWINGS

Reference will now be made to the accompanying drawings, which are not necessarily drawn to scale, and wherein:

FIG. 1 depicts examples of noises from ASR transcription for name entity recognition.

FIG. 2 is a block diagram illustrating an exemplary, non-limiting embodiment of a natural language processing system in accordance with various aspects described herein.

FIG. 3 is a block diagram illustrating an exemplary, non-limiting embodiment of another natural language processing system in accordance with various aspects described herein.

FIG. 4A depicts an illustrative embodiment of a method in accordance with various aspects described herein.

FIG. 4B depicts an illustrative embodiment of another method in accordance with various aspects described herein.

FIG. 4C depicts an illustrative embodiment of further another method in accordance with various aspects described herein.

FIG. 5 is a block diagram of an example, non-limiting embodiment of a computing environment in accordance with various aspects described herein.

### DETAILED DESCRIPTION

The subject disclosure describes, among other things, illustrative embodiments for natural language processing systems and methods for performing an improved named entity recognition on speech transcription using a ground truth transcription for training. Other embodiments are described in the subject disclosure.

One or more aspects of the subject disclosure are directed to a device including a processing system including a processor, and a memory that stores executable instructions that, when executed by the processing system, facilitate performance of operations. The operations include receiving a first text input that represents entity description at an entity encoder, receiving a second text input that represents Automatic Speech Recognition (ASR) transcription at a text encoder, receiving a third text input that represents ground truth transcription at the text encoder, performing embeddings of the first text input, the second text input, and the third text input, training a natural language processing model, and generating a predicted entity output and a predicted non-entity output using the trained natural language processing model. The training the natural language processing model includes tying first sentence embeddings in the first text input with entity span embeddings in the second text input by applying triplet loss in a common vector space, based on a triplet loss value, adjusting a distance between the first sentence embeddings in the first text input and the entity span embeddings in the second text input, and tying second sentence embeddings in the second text input and third sentence embeddings in the third text input on same utterances by applying a cosine loss in the common embedding space.

One or more aspects of the subject disclosure are directed to a non-transitory machine-readable medium, comprising executable instructions that, when executed by a processing system including a processor, facilitate performance of operations. The operations include receiving an entity description including an entity type special token at an entity type encoder, receiving automatic speech recognition (ASR) transcription at a text encoder, wherein the ASR transcription further comprises an ASR special token, an ASR non-entity span and an ASR entity span, receiving a manual transcription including a manual special token and a manual entity span at the text encoder, generating first embeddings of the entity type special token in a common vector space, generating second embeddings of the ASR special token, the ASR non-entity span and the ASR entity span in the common vector space, generating third embeddings of the manual special token in the common vector space, adjusting a first distance of the second embeddings of the ASR special token from the third embeddings of the manual special token, and generating a predicted entity output and a predicted non-entity output based on the first embeddings of the entity type special token and the second embeddings of ASR special token, the ASR non-entity span and the ASR entity span.

One or more aspects of the subject disclosure are directed to a method including receiving, by a processing system including a processor, a manual transcription at a text encoder, receiving, by the processing system, an automatic speech recognition (ASR) transcription at the text encoder, receiving, by the processing system, an entity type description at an entity type encoder, generating, by the processing system, a natural language processing model by training the text encoder to learn from both the manual transcription and the ASR transcription, and generating a predicted entity output and a predicted non-entity output using the trained natural language processing model. The training includes setting a reference point based on embeddings of the entity type description; using a triplet loss function, maximizing a distance between the reference point and embeddings of an ASR non-entity span and minimizing a distance between the reference point and embeddings of an ASR entity span; using a contrastive loss, minimizing a distance between sentence embeddings of the ASR transcription and sentence embeddings of the manual transcription; and using the contrastive loss, minimizing a distance between embeddings of an ASR entity span and embeddings of a manual entity span.

A spoken language understanding (SLU) system includes an automatic speech recognition (ASR) engine that converts speech signals into transcripts. The SLU system further includes a natural language understanding (NLU) model to perform downstream analytics. Applications of the SLU system include intent classification, keyword extraction, named entity recognition, sentimental analysis, etc. For an intent classification application, a speaker who provides an audio input to the ASR engine has a certain intent and the NLU model attempts to understand the intent in order to provide the most relevant response or take a relevant action.

For named entity recognition, a user types a query or question in natural language and searches the Internet. For instance, a user's query is “where was Obama born?” Alternatively, a user speaks a query, “where was Obama born?” The NLU model can recognize named entity (i.e., Obama, an entity type: PERSON). As further another example, sentiment analysis is another application of NLP which tries to understand sentiment of speakers, users, customers, etc. (e.g., opinions and stances) through NLP on web, social media, other online sources, etc.

Compared to textual language, spoken language is less structured and more challenging to process than textual language or written language, because of speech overlapping, filler words, interruptions, etc. Moreover, speech can be considered as personally identifiable information and there are relevant regulatory or legal requirements and/or restrictions in analyzing and storing speech as data. Accordingly, speech data or audio data may not be readily available for training the ASR engine and the NLP systems. In addition, compared to the manual transcription, ASR transcripts may contain more noise and be prone to errors.

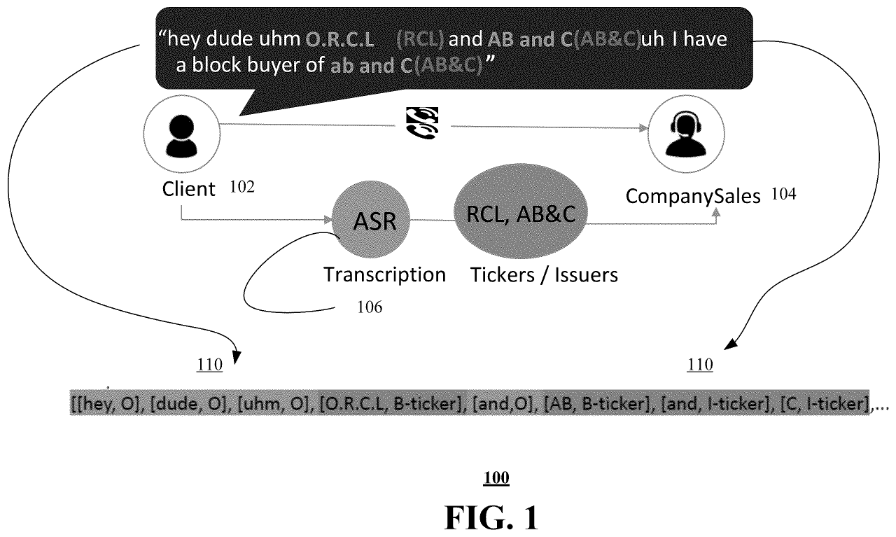

The noise and errors contained in the ASR transcripts significantly affects applications of named entity recognition (NER). FIG. 1 depicts examples of noises from ASR transcription for name entity recognition. In particular, FIG. 1 depicts examples for a specific use case 100 where a target entity in the application of named entity recognition (NER) corresponds to tickers or issuers of credit (bond) products mentioned in real-time calls between a client 102 and a company sales representative 104. The client's speech is converted into ASR transcripts by an ASR engine 106 and the NER application to recognize tickers or issuers.

As depicted in FIG. 1, the client's speech iterates, as an example, “hey dude uhm O.R.C.L (RCL) and AB and C (AB & C) uh I have a block buyer of ab and C (AB & C).” After the conversion by the ASR engine 106, a transcription 110, “[hey, O], [dudu, O], [uhm, O], [O.R.C.L, B-ticker], [and, O], [AB, B-ticker], [and, I-ticker], [C, I-ticker], . . . ” is resulted from the conversion. From the transcription 110, identifying bond tickers or issuers that are mentioned in real time when traders are speaking to the company sale representative or agents on the phone involves named entity recognition (NER) and named entity disambiguation (NED). The present disclosure is directed to NER which aims at detecting all possible mentions of named entities, which are tickers and issuers in use cases, in an automatic speech recognition (ASR) transcription.

Compared to NER on text document, NER on ASR transcription with noises is a much more challenging task at least for several reasons. NER models are typically sensitive to word shape features (i.e., casing, with or with dot, “ab and C” vs “AB & C”), misspelled entities (i.e., “a van” instead of “Avantor”) or poorly formatted entities (i.e., “E. T. F.” instead of “ETF”, which tends to be tokenized as three word-pieces, “E”, “T”, “F”), which may typically appear in the ASR transcription. NER models are context-based. Conversational English, particularly conversations between traders and sales agents in the use case depicted in FIG. 1, is short of context and also contains a lot of financial terms, slangs, and abbreviations, which may pose a challenge to an NER model. It can be more challenging to the NER model, when compared to handling formal text documents (e.g., news data or research papers). The NER model, when trained only on generic text documents, may not work as expected with respect to the ASR transcription.

Referring back to FIG. 1, the following type of errors may be resulted from the ASR transcription for performing the NER, as shown in Table 1.

TABLE 1
Example of ASR Transcription Errors for Performing NER

| ASR Error | | | Ground Truth |
|---|---|---|---|
| Type | Manual Transcription | ASR Transcription | Entities |
| Soft | you can sell me AB&C | you can sell me A. B. | AB&C (issuer) |
| Substitution | | and C. | |
| or Insertion | | | |
| (S/I) errors | | | |
| Soft S/I | if you compare versus the | if you compare versus | ECO (index) |
| errors | Bloomberg E. C. O. is a | the | |
| | bit higher than that | Bloomberg C.C.O. is a | |
| | | bit higher than that | |
| Severe S/I | They're literally has been | They're literally has | None |
| errors | no other buyer | been no other Bayer | |
| Severe S/I | Avantor three twenty- | avatar. Uh 2 25 a | Avantor (issuer) |
| errors | five Avantor sorry. | van sorry. | |
| Deletion | Uh oh. Um she | Uh oh. Um she | XYZ (issuer), |
| errors | is gonna be trading XYZ, | is gonna be trading | KJ |
| | which is the KJ media? | <missing>, which is | Media (issuer) |
| | | the <missing> media? | |

As shown in Table 1 above, ASR errors affecting the NER include, by way of example, soft substitution or insertion errors, severe substitution or insertion errors, deletion errors, etc. Therefore, an artificial intelligent (AI) model trained on generic text documents may not perform well in the NER use case.

A baseline NLP system includes a text encoder for a ground truth transcription and another text encoder for an ASR transcription. Each text stream from each text encoder is subject to text embeddings and sent to a token classifier. As a result, detected entities are determined from the ground truth transcription and the ASR transcription. The baseline NLP system, upon training with the ground truth transcription only, or the ASR transcription only, can predict an entity from a user input with different accuracy levels. For instance, the baseline NLP system is configured to generate a predicted entity based on the ground truth transcription input upon training with a ground truth transcript evaluation set or an ASR transcription evaluation set. As another example, the baseline NLP system is configured to generate a predicted entity based on the ASR transcription input using training with the ground truth transcription evaluation set or the ASR transcription evaluation set. The baseline NLP system trained on manual transcription training set tends to produce more accurate results on manual transcription evaluation set. Similarly, the baseline system trained on ASR transcription training set tends to produce more accurate results on ASR transcription evaluation set. The baseline NLP system shows the lowest accuracy when trained with the ASR transcription training set and evaluated on manual transcription evaluation set or vice versa.

In various embodiments, the ground truth transcription can be referred to as a manual transcription or a gold transcription and the ground truth transcription, the gold transcription or the manual transcription is used interchangeably in the present disclosure. The ground truth transcription or the gold transcription or the manual transcription is manually transcribed to ensure the highest possible accuracy. The ground truth transcription or the gold transcription or the manual transcription serves as a reference object, when compared with the ASR transcription, and as the ASR transcription is more similar or closer to the manual transcription, the ASR transcription can be considered as more accurate.

The baseline model may include a tying process of text embeddings from the gold transcription and text embeddings from the ASR transcription in a common embedding space. Tying the gold transcription text embeddings to the ASR transcription text embeddings enables the text encoder to learn from both the ground truth transcription (i.e., the gold transcription) and the ASR transcription. In some embodiments, the text encoder is implemented with bi-encoders including an ASR encoder and a pre-trained text encoder. By tying the gold transcription text embeddings to the ASR transcription text embeddings, the ASR encoder can be trained by using the pre-trained text encoder which involves the gold transcription. However, the baseline model using the tying process of the text embeddings from the gold transcription and the ASR transcription operates as a sentence classification task. For example, the baseline model detects a sentiment or an intent from a sentence uttered by a speaker. NER models involve a token classification task, and at least for that reason, application of the baseline model using the tying process to NEL models may not be an easy and effective fit.

To addresses the above challenges involving NER models, in various embodiments, the present disclosure is directed to natural language processing systems and methods for performing an improved named entity recognition on speech transcription using a ground truth transcription for training. The present disclosure describes a framework that is robust to ASR errors and adapted to perform better in specialized domains such as a finance domain. The present disclosure includes a bi-encoder framework for NER that utilizes contrastive learning to map entity spans and entity type description into a shared vector space and maximize similarity between entity span text embeddings and their corresponding description embeddings. The present disclosure further describes extending the bi-encoder framework by adding an ASR encoder and tying embeddings of (i) a classification (CLS) token of the ground truth transcription and a CLS token of the ASR transcription via a cosine loss and (ii) the entity spans in the ground truth transcription and the entity spans in the ASR transcription via the cosine loss.

In various embodiments, the present disclosure provides an AI model which can learn to encode a sentence and target entities in the ASR transcription similarly to how it encodes in the ground truth transcription, thereby achieving robust performance against ASR noises and errors.

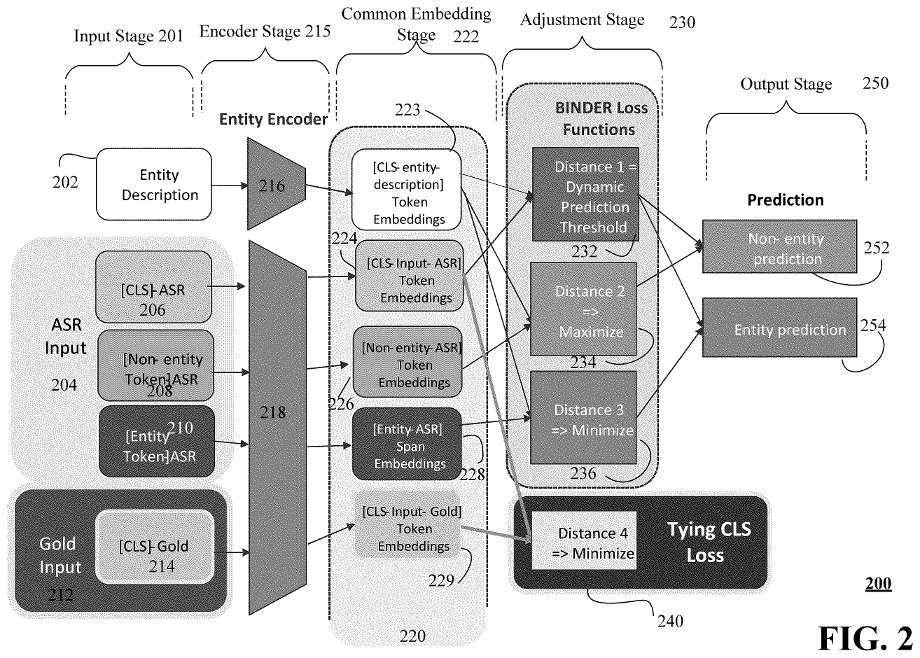

FIG. 2 is a block diagram illustrating an exemplary, non-limiting embodiment of a natural language processing system in accordance with various aspects described herein. The natural language processing (NLP) system 200 includes an input stage 201, an encoder stage 215, a common embedding stage 222, an adjustment stage 230, and an output stage 250, as depicted in FIG. 2.

In various embodiments, the input stage 201 includes entity description 202, an ASR input 204 and a gold input 212 (i.e., a ground truth input). The entity description 202 contains natural language descriptions of different entities, such as a person, an organization, a location, an event, a product, an address, a uniform resource locator (URL), etc. By way of example only, referring back to FIG. 1, the entity description 202 contains a ticker, an issuer, etc. In some embodiments, the entity description 202 include a format of a prepended token or a special token (CLS), entity description and an appended token.

The special token [CLS] is placed at the beginning of the input sequence. The embedding of the [CLS] token, generated by the text encoder, serves as the input representation for classification tasks in NLP and machine learning applications. The special token [CLS] encapsulates information from the entire input sequence and carries it through an NLP model's layers for further processing. The NLP model then uses this representation to make predictions or classify the input into predefined categories. The special token [CLS] plays an important role in NLP tasks as [CLS] enables the NLP model to perform classification on text data. As [CLS] incorporates the entire input sequence into a single representation, the NLP model can capture relevant context and semantic information that assists in accurate classification. In other words, [CLS] helps the NLP model to understand the relationship between different words and their impact on the overall meaning of the text.

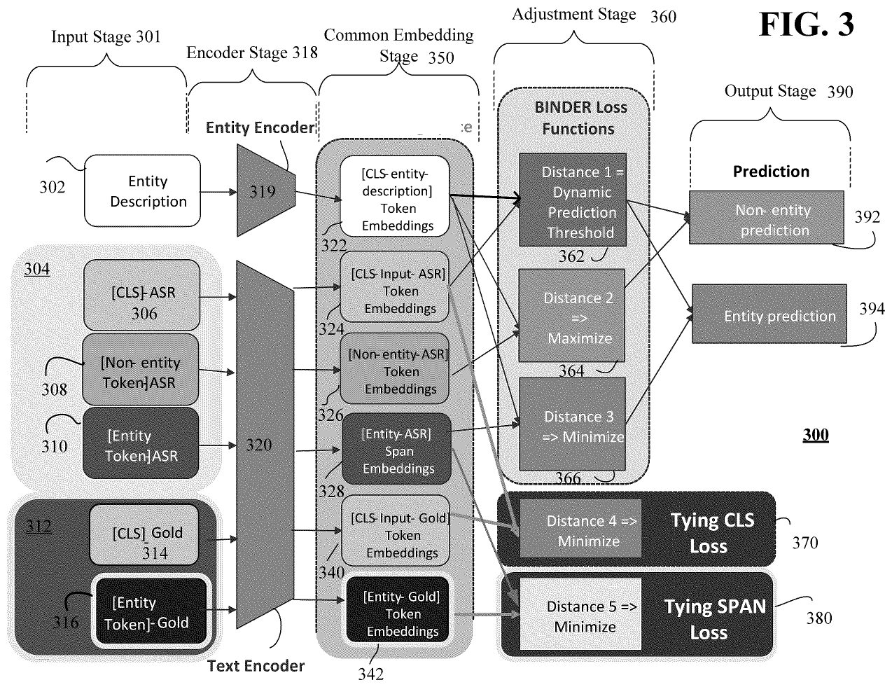

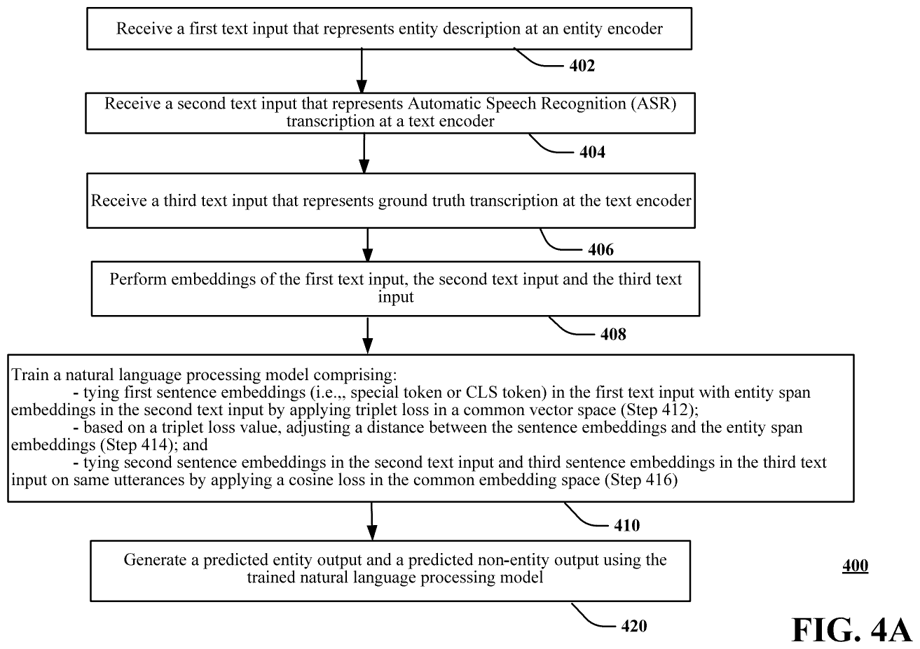

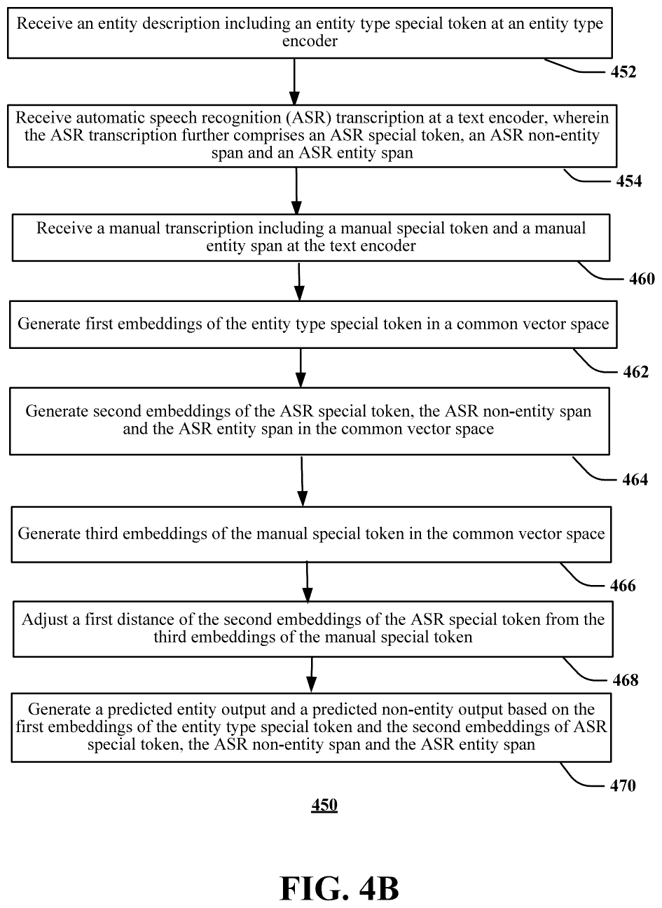

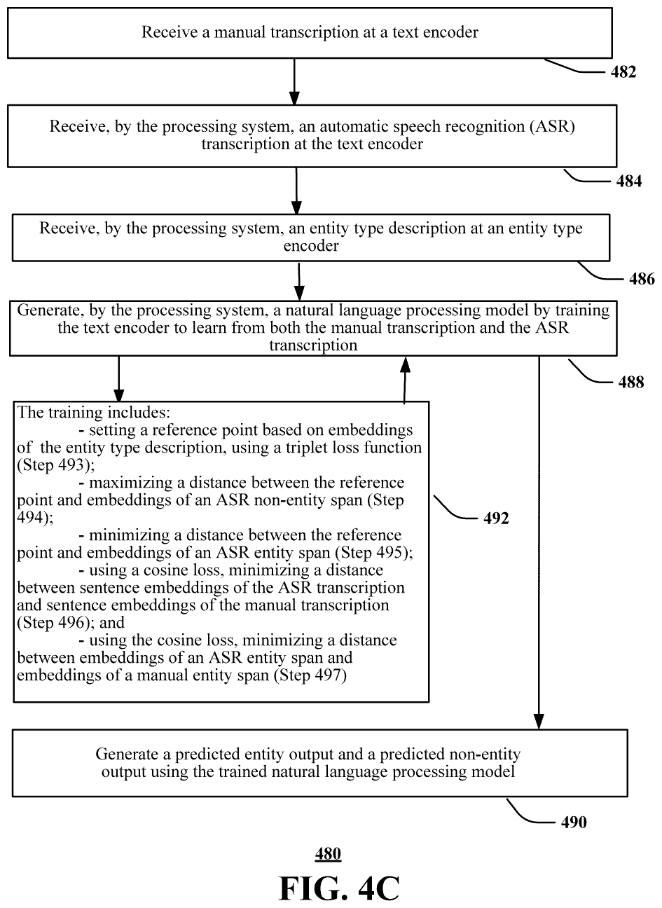

In various embodiments, the ASR input 204 includes a text input which is converted and recognized from speech via an ASR engine. To obtain the ASR transcription, a currently available ASR engine can be used. The present disclosure is not limited to a particular ASR engine. The text input based on the ASR transcription is tokenized into a special token 206 ([CLS]-ASR), a non-entity token 208 ([non-entity Token]-ASR) and an entity token 210 ([Entity Token]-ASR). For training, pre-training span matching using a Character-Error-Rate (CER) based matching algorithm is performed and as a result, matching pairs of entities in an ASR text and a manual text are output, as described in detail below. In various embodiments, a gold input 212, based on a ground truth transcription, includes a special token 214 ([CLS]-Gold). The gold input 212 includes more tokenized words, which will be described later in connection with FIGS. 3 and 4B. By way of example, referring to the example depicted in FIG. 1, the entity description 202 corresponds to description for Issuer, the ASR input 204 corresponds to “You can sell me A.B. and C.,” and the gold input 212 corresponds to “You can sell me AB & C.” The ASR input 204 may be tokenized, “you,” “can,” “sell,” “me,” “A.B.,” “and,” “C.” Likewise, the gold input 212 may be tokenized, “you,” “can,” “sell,” “me,” “AB,” “&,” “C.”

In various embodiments, the encoder stage 215 includes an entity type encoder 216 that receives the entity description 202. At the encoder stage 215, each input is subject to embeddings which convert words from the inputs 202, 204 and 212 into a vector. The entity type encoder 216 operates to produce entity type representations. A text encoder 218 receives both the ASR input 204 and the gold input 212 substantially simultaneously.

A BI-encoder for NameD Entity Recognition (BINDER) has been proposed to “separately map text and entity types into the same vector space.” Zhang et al., “Optimizing bi-encoder for named entity recognition via contrastive learning,” ICLR 2023 at p. 1 (hereinafter, referred to as “the Zhang paper”). The Zhang paper further describes using a unified contrastive learning framework for NER. In the Zhang paper, an entity type encoder and a text encoder are used to receive text input and entity type inputs; however, no ground truth transcription is used in the BINDER proposed by the Zhang paper.

In some embodiments, the entity type encoder 216 and the text encoder 218 may be implemented to use a special classification token, [CLS] to be added at the beginning of a text input. The [CLS] is encoded to include all representative information of all tokens through a multi-layer encoding procedure. The representation of [CLS] is individual in different sentences. In the text encoder, the [CLS] is used as a special classification token and a final hidden state corresponding to [CLS] is used as an aggregate sequence representation for classification tasks. The [CLS] token is used as the input for the classification tasks in the text encoder, where the model learns to predict a correct label or category for a given input. The [CLS] token is typically followed by a classification layer that takes the representation of the [CLS] token as an input and produces a final classification output. This allows the text encoder to perform tasks such as sentiment analysis, text classification, question answering, and named entity recognition as described in the present disclosure.

In various embodiments, in the NLP system 200, the entity type encoder 216 produces special token embeddings (i.e., [CLS-entity-description] token embeddings 233) which will be used as a reference point in a vector space for contrastive learning. See the Zhang paper at p. 2 and FIG. 1. The text encoder 218 produces special token embeddings of the ASR input 204 (i.e., [CLS-input-ASR] token embeddings 224). The text encoder 218 further produces special token embeddings of the gold input 212 (i.e., [CLS-input-Gold] token embeddings 229). The text encoder 218 further produces [Non-entity-ASR] token embeddings 226 and [Entity-ASR] token embeddings 228, which correspond to candidate spans of the ASR input 204. The candidate spans of the ASR input 204 may include named entity or entities.

In various embodiments, all of the token embeddings 223, 224, 226, 228 and 229 produced from the entity encoder 216 and the text encoder 218 are subject to the common embedding stage 222. That is, all of the token embeddings 223, 224, 226, 228 and 229 are mapped in the same vector space 220 such that necessary tying of different embeddings can be performed. First, tying of the [CLS-entity-description] token embeddings 223 and the [CLS-input-ASR] token embeddings 224 is performed. A distance between the [CLS-entity-description] token embeddings 223 and the [CLS-input-ASR] token embeddings 224 is computed and determined as Distance 1 (shown as 232 in FIG. 2). As described above, the representation of [CLS] reads the entire input text and summarizes contextual information.

In various embodiments, comparison of the [CLS-entity-description] token embeddings 223 and the [Non-entity-ASR] token embeddings 226 is performed. A distance between the [CLS-entity-description] token embeddings 223 and the [Non-entity-ASR] token embeddings 226 is computed and determined as Distance 2 (shown as 234 in FIG. 2). Tying of the [CLS-entity-description] token embeddings 223 and the [Entity-ASR] token embeddings 228 is performed and a distance between the [CLS-entity-description] token embeddings 223 and the [Entity-ASR] token embeddings 228 is computed and determined as Distance 3 (shown as 236 in FIG. 2). Tying of the [CLS-input-ASR] token embeddings 224 and the [CLS-input-gold] token embeddings 229 is performed and a distance between the [CLS-input-ASR] token embeddings 224 and the [CLS-input-gold] token embeddings 229 is computed and determined as Distance 4 (shown as 240 in FIG. 2).

In various embodiments, the NLP system 200 proceeds to the adjustment stage 230 following the common embedding stage 222. At the adjustment stage 230, Distance 1 defines a dynamic prediction threshold 232 which can distinguish entity spans from non-entity spans. In other words, in the vector space, entity spans are positioned within the dynamic prediction threshold 232, a space defined by Distance 1 from the reference point, i.e., the [CLS-entity-description] token embeddings 223, in the vector space, whereas non-entity spans are positioned outside of the dynamic prediction threshold 232, the space defined by Distance 1 from the reference point. The [CLS-entity-description] token embeddings 223 is used as a reference point in the vector space with respect to an entity type representation. The candidate spans of the ASR input 204 can be matched with the entity type representation in the vector space 220.

In various embodiments, at the adjustment stage 230, contrastive learning techniques are applied to train the differences between the span embeddings (e.g., [Non-entity-ASR] token embeddings 226 and [Entity-ASR] token embeddings 228) and entity description embeddings ([CLS-entity-description] token embeddings 223). The contrastive learning techniques are a learning approach that focuses on extracting meaningful representations by contrasting positive and negative pairs of instances. The contrastive learning techniques leverage the assumption that similar instances should be closer together in a learned embedding space, while dissimilar instances should be farther apart. The contrastive learning applied to NER models enables representation of entity types to be similar with a corresponding entity spans, and to be dissimilar with that of other text spans such as non-entity spans. One example of the contrastive learning is a triplet loss.

In various embodiments, at the adjustment stage 230, it is determined whether Distance 2 is greater than Distance 1, serving as the dynamic prediction threshold 232. Upon determination that Distance 2 is greater than Distance 1, a difference between Distance 2 and Distance 1 is maximized during training of the NPL system 200. As described above, the distance between the [CLS-entity-description] token embeddings 223 and the [Entity-ASR] token embeddings 228 is computed and determined as Distance 3. Then it is determined whether Distance 3 is smaller than Distance 1, serving as the dynamic prediction threshold 232. Upon determination that Distance 3 is smaller than Distance 1, a difference between Distance 3 and Distance 1 is minimized during the training of the NPL system 200. In other words, the similarity between the [CLS-entity-description] token embeddings 223 and the non-entity spans based on the [Non-entity-ASR] token embeddings 226 is minimized, whereas the similarity between the [CLS-entity-description] token embeddings 223 and the entity spans based on the [Entity-ASR] token embeddings 228 is maximized.

As described above, the distance between the [CLS-input-ASR] token embeddings 224 and the [CLS-input-gold] token embeddings 229 is computed and determined as Distance 4 (shown as 240 in FIG. 2). The contrastive learning technique is applied to Distance 4 such that Distance 4 is minimized and the similarity between the ASR input 204 and the gold input 212 can be maximized. This adjustment may enable the NLP system 200 to learn the same CLS embeddings for the gold input 212 and the ASR input 204 with respect to the same utterance. Therefore, the NLP system 200 can achieve more robust performance to ASR errors coming from noisy ASR transcripts. In various embodiments, the sentence embeddings of ASR transcription are trained to be as close as possible to the sentence embeddings of gold transcription of the same utterances, so that the NLP model learns the same embeddings for the ground truth transcription and corresponding ASR transcription, thereby resulting in robust performance against ASR noises.

In various embodiments, the sentence embeddings of the ground truth transcription and ASR transcription are tied together in the common embedding space 220 via a cosine loss. This loss function minimizes the distance between the embeddings of the ground truth embeddings and embeddings corresponding the ASR transcription of the same utterances and maximizes the distance of the ground truth transcription and the ASR transcription of different utterances.

In various embodiments, the NLP system 200 includes two input streams at training: the ASR transcription 204 and the ground truth transcription 212 for training. In other words, the NLP system 200 performs the NER on the ASR transcription 204 using the ground truth transcription 212, i.e., training the ASR transcription 204 using the ground truth transcription 212. The two input streams are passed through the text encoder 218 of the BINDER to make the NLP system 200 simultaneously learn from both the ground truth transcription and the ASR transcription of the same utterance during the training phase. In addition to BINDER loss functions 234 and 236 based on adjustment of Distance 2 and Distance 3, a new loss function may be added as a contrastive loss that represents the distance between the sentence embeddings (CLS) 240 of the ground truth transcription 212 and the sentence embeddings (CLS) of the ASR transcription 204. This contrastive loss is designed to tie these two sentence embeddings together and train the text encoder 218 to be robust to noises or errors contained in the ASR transcription 204.

In various embodiments, at the output stage 250, a non-entity prediction 252 is output as a result of maximizing Distance 2 based on the contrastive learning and an entity prediction 254 is output as a result of minimizing Distance 3. With respect to the non-entity prediction 252 and the entity prediction 254, the dynamic prediction threshold 232 is used to separate the entity spans from the non-entity spans. By way of example only, at the output stage 250, an entity prediction 254 may be “A.B. and C,” which is guided by “Issuer” from the entity type encoder 216. Span embeddings are performed with respect to the tokenized representations and in order to learn the relation between Issuer and AB & C, span candidates based on corresponding token representations are matched with each entity type in the vector space. The NLP system 200 further learns “AB & C” from the ground truth transcription 214 which is tied with the ASR transcription 204 and adjusted via a cosine loss that represents the distance between the sentence embeddings (CLS) of the ground truth transcription 214 and the sentence embeddings (CLS) of the ASR transcription 204.

In various embodiments, the NLP system 200 applies the BINDER loss simultaneously on two input streams, the ASR and the ground truth transcriptions 204, 212, to have the text encoder 218 learn from both and the ground truth transcriptions 204, 212. At the common embedding stage 222, the sentence embeddings (CLS) 229 of the ground truth transcription 214 and the sentence embeddings (CLS) 224 of the ASR transcription 204 of the same utterance are tied. At the adjustment stage 230, via contrastive loss, the text encoder 218 can learn the same embeddings for the ground truth transcription 212 and the ASR transcription 204 and become robust against ASR errors.

FIG. 3 is a block diagram illustrating an exemplary, non-limiting embodiment of another natural language processing system in accordance with various aspects described herein. The natural language processing (NLP) system 300 includes an input stage 301, an encoder stage 318, a common embedding stage 350, an adjustment stage 360, and an output stage 390, as depicted in FIG. 3.

In various embodiments, the input stage 301 includes entity description 302, an ASR input 304 and a gold input 312 (i.e., a ground truth input). The entity description 302 contains natural language descriptions of different entities, such as a person, an organization, a location, an event, a product, an address, a uniform resource locator (URL), etc.

In various embodiments, the ASR input 304 includes a text input which is converted and recognized from speech via an ASR engine. The text input based on an ASR transcription is tokenized into a special token 306 ([CLS]-ASR), a non-entity token 308 ([non-entity Token]-ASR) and an entity token 310 ([Entity Token]-ASR). In various embodiments, the gold input 312, based on a ground-truth transcription, includes a special token 314 ([CLS]-Gold). In the NLP system 300, the gold input 312 further includes a [Entity Token]-Gold 316 in addition to [CLS]-Gold 314.

In various embodiments, the encoder stage 318 includes an entity type encoder 319 that receives the entity description 302. At the encoder stage 318, each input is subject to embeddings which convert words from the inputs 302, 304 and 312 into a vector. The entity type encoder 216 operates to produce entity type representations. A text encoder 320 receives both the ASR input 304 and the gold input 312 and produces the ASR embeddings and gold embeddings. These input pipelines are parallel until the encoder stage 215 where the embeddings are generated and after that stage, become independent of each other. The NLP system 300 is not limited to a particular type of text encoders and may include various different text encoders available for natural language processing in the pertinent technical field.

In the NLP system 300, the entity type encoder 319 produces special token embeddings (i.e., [CLS-entity-description] token embeddings 233) which will be used as a reference point in the vector space for contrastive learning. See the Zhang paper at p. 2 and FIG. 1. The text encoder 320 produces special token embeddings of the ASR input 304 (i.e., [CLS-input-ASR] token embeddings 324). The text encoder 320 further produces special token embeddings of the gold input 312 (i.e., [CLS-input-Gold] token embeddings 340). The text encoder 320 further produces [Non-entity-ASR] token embeddings 326 and [Entity-ASR] token embeddings 328, which correspond to candidate spans of the ASR input 304. The candidate spans of the ASR input 204 may include named entity or entities.

In various embodiments, all of the token embeddings 323, 324, 326, 328, 340 and 342 produced from the entity encoder 319 and the text encoder 320 are subject to the common embedding stage 222. That is, all of the token embeddings 322, 324, 326, 328, 340 and 342 are mapped in the same vector space 220 such that necessary tying of different embeddings can be performed. First, tying of the [CLS-entity-description] token embeddings 322 and the [CLS-input-ASR] token embeddings 324 is performed. A distance between the [CLS-entity-description] token embeddings 322 and the [CLS-input-ASR] token embeddings 324 is computed and determined as Distance 1 (shown as 232 in FIG. 2). As described above, the representation of [CLS] reads the entire input text and summarizes contextual information.

In various embodiments, [CLS-entity-description] token embeddings 322 of the entity description is maximized from the [Non-entity-ASR] token embeddings 326. A distance between the [CLS-entity-description] token embeddings 322 and the [Non-entity-ASR] token embeddings 326 is computed and determined as Distance 2 (shown as 234 in FIG. 2). Tying of the [CLS-entity-description] token embeddings 322 and the [Entity-ASR] token embeddings 328 is performed and a distance between the [CLS-entity-description] token embeddings 322 and the [Entity-ASR] token embeddings 328 is computed and determined as Distance 3 (shown as 236 in FIG. 2). Tying of the [CLS-input-ASR] token embeddings 324 and the [CLS-input-gold] token embeddings 340 is performed and a distance between the [CLS-input-ASR] token embeddings 324 and the [CLS-input-gold] token embeddings 340 is computed and determined as Distance 4 (shown as 370 in FIG. 3).

Additionally, in the NLP system 300, tying of the [Entity-ASR] token embeddings 328 and [Entity-Gold] token embeddings 342 is performed and a distance between the [Entity-ASR] token embeddings 328 and [Entity-Gold] token embeddings 342 is computed and determined as Distance 5 (shown as 380 in FIG. 3).

In various embodiments, the NLP system 300 proceeds to the adjustment stage 360 following the common embedding stage 352. At the adjustment stage 360, Distance 1 defines a dynamic prediction threshold 362 which can distinguish entity spans from non-entity spans. In other words, in the vector space, entity spans are positioned within the dynamic prediction threshold 232, a space defined by Distance 1 from the reference point, i.e., the [CLS-entity-description] token embeddings 322, whereas non-entity spans are positioned outside of the dynamic prediction threshold 362. The [CLS-entity-description] token embeddings 322 is used as a reference point in the vector space with respect to an entity type. The span candidates of the ASR input 304 can be matched with the entity type in the same vector space.

In various embodiments, at the adjustment stage 360, contrastive learning techniques are applied to train the differences between the span embeddings (e.g., [Non-entity-ASR] token embeddings 326 and [Entity-ASR] token embeddings 328) and entity description embeddings ([CLS-entity-description] token embeddings 322). At a training time, a difference between Distance 2 and Distance 1 is maximized and a difference between Distance 3 and Distance 1 is minimized. At an inference time, if Distance 2 is greater than Distance 1, the [Non-entity-ASR] token is labeled as a non-entity, and if Distance 2 is lesser than Distance 1, the [Non-entity-ASR] token is labeled as an entity. It should be noted that at the inference time, it is unknown which tokens are entities or non-entities, so there is no distinction between Distance 2 and Distance 3 at the inference time. In other words, the similarity between the [CLS-entity-description] token embeddings 322 and the non-entity spans based on the [Non-entity-ASR] token embeddings 326 is minimized, whereas the similarity between the [CLS-entity-description] token embeddings 322 and the entity spans based on the [Entity-ASR] token embeddings 328 is maximized.

As described above, the distance between the [CLS-input-ASR] token embeddings 324 and the [CLS-input-gold] token embeddings 340 is computed and determined as Distance 4 (shown as 240 in FIG. 2). The contrastive learning technique is applied to Distance 4 such that Distance 4 is minimized and the similarity between the ASR input 304 and the gold input 312 can be maximized. This adjustment may enable the NLP system 300 to learn the same CLS embeddings, which is generally considered to carry the information from the entire input sequence, for the gold input 312 and the ASR input 304 with respect to the same utterance. Therefore, the NLP system 300 can achieve more robust performance to ASR errors coming from noisy ASR transcripts. In various embodiments, the sentence embeddings of ASR transcription are trained to be as close as possible to the sentence embeddings of gold transcription of the similar utterances or utterances of the same intent class, so that the NLP model learns the same embeddings for the ground truth transcription and corresponding ASR transcription, thereby resulting in robust performance against ASR noises.

In various embodiments, the sentence embeddings of the ground truth transcription and ASR transcription are tied together in the common embedding space 220 via a cosine loss. This loss function minimizes the distance between the embeddings of the ground truth [CLS] token embeddings and embeddings of the ASR [CLS] token transcription of the same utterance.

In various embodiments, the NPL system 300 further includes another contrastive loss function that aims to tie the embeddings 342 of the entity spans from the gold/ground truth transcription 312 to the embeddings 328 of the corresponding entity spans from the ASR transcription 304 as follows.

### 1. Pre-Training Span Matching

In various embodiments, a Character-Error-Rate (CER) based matching algorithm is prepared. The CER based matching algorithm involves matching annotated spans of entities in a gold transcription to corresponding annotated spans of the entities in an ASR transcription. The CER based matching algorithm is run as a part of data-preprocessing and therefore, run before a training of an NLP system starts. At the end of running the CER based matching algorithm, matching pairs of entities in the gold text and the ASR text are output. The following are one example of the CER based matching algorithm:

### Example of the CER Based Matching Algorithm

GOLD text: Avantor is an issuer and ORCL is a ticker.
ASR text: A vantou is an issuer and RCL is a ticker.
Matched entities: (“Avantor”, “A vantou”), (“ORCL”, “RCL”)

### 2. SPAN Loss

In various embodiments, once the matched spans are in place, the embeddings of both the spans are tied together using contrastive loss techniques. Span embeddings for a span may be modeled as a triplet of the form. More specifically, embedding of a first token in the span, embedding of last token in the span, embedding of a length of the span, will constitute a triplet of the form. By using the above example, embeddings of “A,” “r” and 7” for the gold text span, “Avantor” and embeddings of “A,” “u,” and “8” for the ASR text span, “A vantou,” will constitute a triplet of the form, respectively. Multiple methods of span embeddings, including max-pooling, min-pooling, averaging, or concatenating first and last token embeddings, can be tried out, all of which will give comparable results.

In the NLP system 300, the span matching algorithm may efficiently map the equivalent spans even in the presence of ASR errors. The contrastive loss function to tie the embeddings of entity spans in the gold transcription and the ASR transcription may advance comprehension of the ASR errors by the NLP system 300, which will likely aid the NLP system 300 to recover from performance impacts from the ASR errors.

In various embodiments, the NLP system 200 and the NLP system 300, as depicted in FIGS. 2-3, are subject to training and inference phases. For the training phase, relevant loss functions include the BINDER loss functions, i.e., the dynamic prediction threshold and the triplet loss, the CLS embedding loss, and the span embedding loss (the NLP system 300). With respect to training inputs, during the training phase, a pairs of input texts i.e. (a gold text sentence, an ASR text sentence), along with an actual text, are used, and three more inputs (i.e., gold entity spans, ASR entity spans, Gold-ASR-entity matchings) are further provided. The gold and ASR entity spans denote which tokens in the gold text and ASR text are entities and which entity type do they belong to. The matchings are a set of one-to-one matching between the spans annotated in the gold text and the spans annotated in the ASR text. These denote that these 2 spans correspond to the same mention of the same entity. Here is an example for further explanation:
Gold text: Hi, I am from Lordan and would love to assist you in buying ORCL Stock
ASR Text: Hi, I am from Lord and would love to assist you in eyeing RCL Stock
   Gold Entities: [‘ORCL’]
   ASR Entities: [‘RCL’]
   Gold-ASR Matchings: [{‘ORCL’: ‘RCL’}]
      Note that “Lordan” in this example is a company mention and not classified as a ticker or issuer. Thus, each training input is a 5-tuple in the form:
⇒(Gold Text, ASR Text, Gold Entities, ASR Entities, Gold-ASR Matchings)

In various embodiments, during an inference phase, the NLP system 200 and the NLP system 300 behave in the same manner, other than the text encoder 218, 320 being an ASR text encoder and having no ground truth or gold transcription. During the inference phrase, the NLP system 200 and the NLP system 300 take in one input stream, which is the ASR transcription 204, 304, and the gold, ground truth or manual transcription is not available. During the inference phase, the CLS loss 370 and the span loss 380 are turned off and hence have no effect The NLP system 200 and the NLP system 300 output an entity span and an entity value. See the following example.
Input text (ASR)
   Hi, I am from Lordan and would love to desist you in eyeing Eyeple Stock
Output
   Entity 1
      Entity span: {“start index”: 14, “end index”: 23}
      Entity text: “Lordan”
      Entity type: company
      [Note that entities of interests here are issuers and tickers]
         Entity 2
      Entity span: {“start index”: 63, “end index”: 69}
      Entity text: “Eyeple”
      Entity type: issuer

In various embodiments, data used for NLP artificial intelligence or machine learning model training and evaluation may include proprietary data. Additionally or alternatively, open source data or publicly available data can be used. For instance, data may be sampled from daily use cases such as sales calls and annotated by an internal annotation team. Based on audio files, an ASR transcription is generated and used as a reference when manually transcribing each call. In a NER labeling task, spans containing mentions of relevant named entity to be recognized can be manually selected and assigned with corresponding labels to each span. By way of example only, spans containing mentions of companies, tickers, issuers, indices in each utterance of the manual and ASR transcript can be manually selected and assigned with one of four entity type labels (e.g., companies, tickers, issuers, indices) to each span to be used for NLP artificial intelligence or machine learning model training and evaluation.

In various embodiments, evaluation data due to ASR errors involve some entities which are critically mis-transcribed or completely missing in the ASR transcript. Therefore, a set of entities appearing in final manual and ASR evaluation data may be different, which explains a potential gap in support numbers for ASR and manual test sets.

In various embodiments, training data may be different from evaluation data, as the training data includes pairs of ASR and manually transcribed utterances that contain the same set of entities. The NLP system 200 and the NLP system 300 are supposed to be trained simultaneously on ASR transcription and manual transcription with the same set of labels.

In various embodiments, metrics for evaluation purposes, micro-average F1, precision and recall across all entity classes are considered, which means an average performance across all predictions and all instances of each class are treated with equal importance. By way of example only, performance on 2 ASR test sets, a smaller 373 utterance set, and a larger 5000 utterance test set with a higher number of labeled entities has been considered in connection with the present disclosure. The NLP system described in the above embodiments outperforms all conventional models on both ASR tests sets. The NLP system described in the above embodiments may outperform transformers-based and the original BINDER model described in the Zhang paper on the proprietary dataset by up to 40% when trained on the same set of data.

FIG. 4A depicts an illustrative embodiment of a method in accordance with various aspects described herein. In various embodiments, the method 400 include receiving a first text input that represents entity description at an entity encoder (Step 402), receiving a second text input that represents Automatic Speech Recognition (ASR) transcription at a text encoder (Step 404), receiving a third text input that represents ground truth transcription at the text encoder (Step 406), performing sentence embeddings of the first text input, the second text input, and of the third text input (Step 408), training a natural language processing model (Step 410), and generating a predicted entity output and a predicted non-entity output using the trained natural language processing model (Step 420).

In various embodiments, the training the natural language processing model (Step 410) includes tying first sentence embeddings in the first text input with the entity span embeddings in the second text input by applying triplet loss in a common vector space (Step 412), based on a triplet loss value, adjusting a distance between the first sentence embeddings in the first text input and the entity span embeddings in the second text input (Step 414), and tying second sentence embeddings in the second text input and third sentence embeddings in the third text input on same utterances by applying a cosine loss in the common embedding space (Step 416).

In various embodiments, the training the natural language processing model further includes determining a distance between the second sentence embeddings in the second text input and the third sentence embeddings in the third text input. The training the natural language processing model further includes minimizing the distance between the second sentence embeddings in the second text input and the third sentence embeddings in the third text input via the cosine loss.

In various embodiments, the method 400 further include, prior to the training of the natural language processing model, running a character-error-rate based matching algorithm with respect to annotated spans of entities in a manual text and corresponding annotated spans of the entities in an ASR text, and outputting matching pairs of entities from the manual text and the ASR text. The method 400 further includes tying embeddings of entity spans from the ASR transcription and embeddings of entity spans from the ground truth transcription via the cosine loss. The method 400 further comprise executing a span matching algorithm to map equivalent entity spans in the ASR transcription and the ground truth transcription for training.

FIG. 4B depicts an illustrative embodiment of another method in accordance with various aspects described herein. In various embodiments, the method 450 includes receiving an entity description including an entity type special token at an entity type encoder (Step 452), receiving automatic speech recognition (ASR) transcription at a text encoder (Step 454), wherein the ASR transcription further comprises an ASR special token, an ASR non-entity span and an ASR entity span (Step 454), receiving a manual transcription including a manual special token and a manual entity span at the text encoder (Step 460), generating first embeddings of the entity type special token in a common vector space (Step 462), generating second embeddings of the ASR special token, the ASR non-entity span and the ASR entity span in the common vector space (Step 464), generating third embeddings of the manual special token in the common vector space (Step 466), adjusting a first distance of the second embeddings of the ASR special token from the third embeddings of the manual special token (Step 468), and generating a predicted entity output and a predicted non-entity output based on the first embeddings of the entity type special token and the second embeddings of ASR special token, the ASR non-entity span and the ASR entity span (Step 470).

In various embodiments, the adjusting the first distance further comprises minimizing the distance between the second embeddings of the ASR special token and the embeddings of the manual special token. The method 450 further comprise training the text encoder based on both the ASR transcription and the manual transcription substantially simultaneously. The method 450 further comprise generating fourth embeddings of a manual entity span from the manual transcription, and adjusting a second distance between the second embeddings of the ASR entity span from the fourth embeddings of the manual entity span via a cosine loss. The method 450 further comprise determining a third distance between the first embeddings of the entity type special token and the second embeddings of the ASR special token, setting a dynamic prediction threshold based on the third distance, and with reference to the dynamic prediction threshold, determining each distance between the second embeddings of the ASR non-entity span and the first embeddings of the entity type special token and between the second embeddings of the ASR entity span and the first embeddings of the entity type special token.

FIG. 4C depicts an illustrative embodiment of another method in accordance with various aspects described herein. In various embodiments, the method 480 includes receiving a manual transcription at a text encoder (Step 482), receiving an automatic speech recognition (ASR) transcription at the text encoder (Step 484), receiving an entity type description at an entity type encoder (Step 486), generating a natural language processing model by training the text encoder to learn from both the manual transcription and the ASR transcription (Step 488), and generating a predicted entity output and a predicted non-entity output using the trained natural language processing model (Step 490). The training (Step 492) includes setting a reference point based on embeddings of the entity type description, using a triplet loss function (Step 493); maximizing a distance between the reference point and embeddings of an ASR non-entity span (Step 494) and minimizing a distance between the reference point and embeddings of an ASR entity span (Step 495); using a cosine loss, minimizing a distance between sentence embeddings of the ASR transcription and sentence embeddings of the manual transcription (Step 496); and using the cosine loss, minimizing a distance between embeddings of an ASR entity span and embeddings of a manual entity span (Step 497).

In various embodiments, the method 480 includes, during an inference phase, receiving an ASR utterance, and in response to the ASR utterance, generating a resulting predicted entity output and a resulting predicted non-entity output using the trained natural language processing model. At inference time, no manual transcriptions or manual entities are used and hence no tying is possible. At inference time, BINDER and AR-BINDER are completely identical in terms of architecture.

In various embodiments, the method 480 includes executing, by the processing system, a span matching algorithm that maps equivalent entity spans in the ASR transcription and the manual transcription. The training (Step 492) further comprises receiving a manually annotated text, receiving a corresponding ASR text, and outputting a set of input including manual entity spans, ASR entity spans and manual-ASR-entity matchings. The manual entity spans indicate which tokens in the manually annotated text are entities and entity types thereof, the ASR entity spans indicate which tokens in the ASR text are entities and entity types thereof, and the manual-ASR-entity matchings correspond to a set of one-to-one matchings between the manual entity spans in the manually annotated text and the ASR entity spans in the corresponding ASR text.

The method 480 further includes determining a dynamic prediction threshold based on a distance from the embeddings of a special token associated with the entity type description to the embeddings of a special token associated with the ASR transcription, wherein the embeddings of the ASR non-entity span are positioned outside of the dynamic prediction threshold and the embeddings of the ASR entity span are positioned within the embeddings of the ASR entity span in a same vector space.

While for purposes of simplicity of explanation, the respective processes are shown and described as a series of blocks in FIGS. 4A, 4B and 4C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

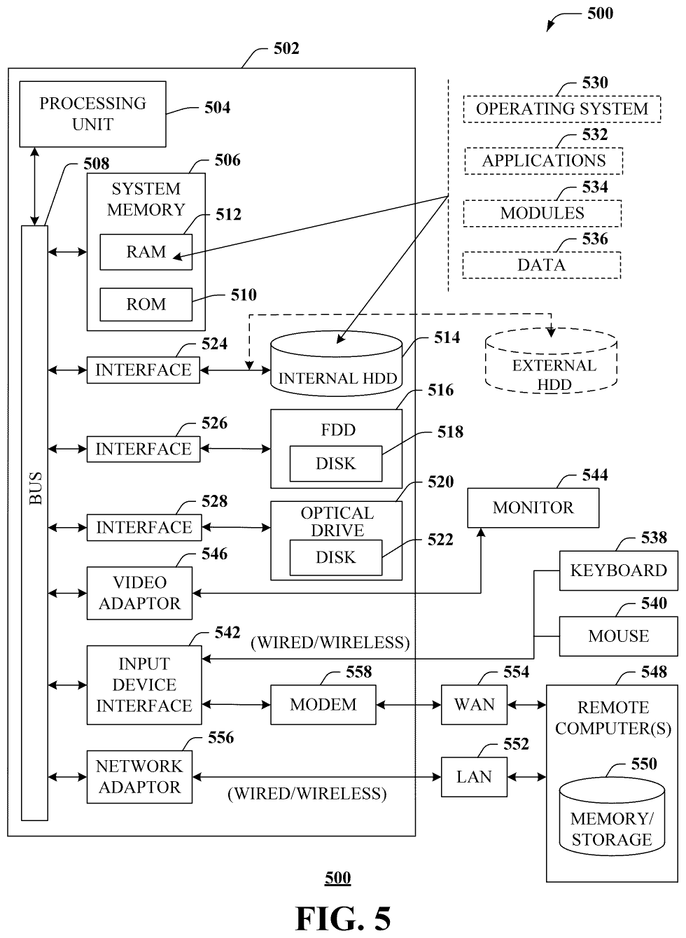

FIG. 5 is a block diagram of an example, non-limiting embodiment of a computing environment in accordance with various aspects described herein.

In order to provide additional context for various embodiments of the embodiments described herein, FIG. 5 and the following discussion are intended to provide a brief, general description of a suitable computing environment 500 in which the various embodiments of the subject disclosure can be implemented. For example, computing environment 500 can facilitate in whole or in part for performing an improved named entity recognition on speech transcription using a ground truth transcription.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 5, the example environment can comprise a computer 502, the computer 502 comprising a processing unit 504, a system memory 506 and a system bus 508. The system bus 508 couples system components including, but not limited to, the system memory 506 to the processing unit 504. The processing unit 504 can be any of various commercially available processors. Dual microprocessors and other multiprocessor architectures can also be employed as the processing unit 504.

The system bus 508 can be any of several types of bus structure that can further interconnect to a memory bus (with or without a memory controller), a peripheral bus, and a local bus using any of a variety of commercially available bus architectures. The system memory 506 comprises ROM 510 and RAM 512. A basic input/output system (BIOS) can be stored in a non-volatile memory such as ROM, erasable programmable read only memory (EPROM), EEPROM, which BIOS contains the basic routines that help to transfer information between elements within the computer 502, such as during startup. The RAM 512 can also comprise a high-speed RAM such as static RAM for caching data.

The computer 502 further comprises an internal hard disk drive (HDD) 514 (e.g., EIDE, SATA), which internal HDD 514 can also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high-capacity optical media such as the DVD). The HDD 514, magnetic FDD 516 and optical disk drive 520 can be connected to the system bus 508 by a hard disk drive interface 524, a magnetic disk drive interface 526 and an optical drive interface 528, respectively. The hard disk drive interface 524 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 502, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 512, comprising an operating system 530, one or more application programs 532, other program modules 534 and program data 536. All or portions of the operating system, applications, modules, and/or data can also be cached in the RAM 512. The systems and methods described herein can be implemented utilizing various commercially available operating systems or combinations of operating systems.

A user can enter commands and information into the computer 502 through one or more wired/wireless input devices, e.g., a keyboard 538 and a pointing device, such as a mouse 540. Other input devices (not shown) can comprise a microphone, an infrared (IR) remote control, a joystick, a game pad, a stylus pen, touch screen or the like. These and other input devices are often connected to the processing unit 504 through an input device interface 542 that can be coupled to the system bus 508, but can be connected by other interfaces, such as a parallel port, an IEEE 1394 serial port, a game port, a universal serial bus (USB) port, an IR interface, etc.

A monitor 544 or other type of display device can be also connected to the system bus 408 via an interface, such as a video adapter 546. It will also be appreciated that in alternative embodiments, a monitor 544 can also be any display device (e.g., another computer having a display, a smart phone, a tablet computer, etc.) for receiving display information associated with computer 502 via any communication means, including via the Internet and cloud-based networks. In addition to the monitor 544, a computer typically comprises other peripheral output devices (not shown), such as speakers, printers, etc.

The computer 502 can operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically comprises many or all of the elements described relative to the computer 502, although, for purposes of brevity, only a remote memory/storage device 550 is illustrated. The logical connections depicted comprise wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which can connect to a global communications network, e.g., the Internet.

When used in a LAN networking environment, the computer 502 can be connected to the LAN 552 through a wired and/or wireless communication network interface or adapter 556. The adapter 556 can facilitate wired or wireless communication to the LAN 552, which can also comprise a wireless AP disposed thereon for communicating with the adapter 556.

When used in a WAN networking environment, the computer 502 can comprise a modem 558 or can be connected to a communications server on the WAN 554 or has other means for establishing communications over the WAN 554, such as by way of the Internet. The modem 558, which can be internal or external and a wired or wireless device, can be connected to the system bus 508 via the input device interface 542. In a networked environment, program modules depicted relative to the computer 502 or portions thereof, can be stored in the remote memory/storage device 550. It will be appreciated that the network connections shown are example and other means of establishing a communications link between the computers can be used.

The computer 502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a first text input that represents entity description at an entity encoder;
receiving a second text input that represents Automatic Speech Recognition (ASR) transcription at a text encoder;
receiving a third text input that represents ground truth transcription at the text encoder;
performing embeddings of the first text input, the second text input, and the third text input;
training a natural language processing model comprising:
tying first sentence embeddings in the first text input with entity span embeddings in the second text input by applying triplet loss in a common vector space;
based on a triplet loss value, adjusting a distance between the first sentence embeddings and the entity span embeddings in the second text input; and
tying second sentence embeddings in the second text input and third sentence embeddings in the third text input on same utterances by applying a cosine loss in the common embedding space; and
generating a predicted entity output and a predicted non-entity output using the trained natural language processing model.

2. The device of claim 1, wherein the training the natural language processing model further comprises determining a distance between the second sentence embeddings of the second text input and the third sentence embeddings of the third text input.

3. The device of claim 2, wherein the training the natural language processing model further comprises minimizing the distance between the second sentence embeddings of the second text input and the third sentence embeddings of the third text input via the cosine loss.

4. The device of claim 1, wherein the operations further comprise:
prior to the training of the natural language processing model, running a character-error-rate based matching algorithm with respect to annotated spans of entities in a manual text and corresponding annotated spans of the entities in an ASR text; and
outputting matching pairs of entities from the manual text and the ASR text.

5. The device of claim 1, wherein the operations further comprises tying embeddings of entity spans from the ASR transcription and embeddings of entity spans from the ground truth transcription via the cosine loss.

6. The device of claim 1, wherein the operations further comprise executing a span matching algorithm to map equivalent entity spans in the ASR transcription and the ground truth transcription for training.

7. The device of claim 1, wherein the tying the first sentence embeddings in the first text input with entity span embeddings in the second text input further comprises:
setting the first sentence embeddings in the first text input as a reference point in a common vector space; and
determining a dynamic prediction threshold by computing a first distance between the reference point and the second sentence embeddings of the ASR transcription.

8. The device of claim 7, wherein the tying the first sentence embeddings in the first text input with the entity span embeddings in the second text input further comprises determining whether the entity span embeddings are within the dynamic prediction threshold; and
wherein the adjusting the distance between the first sentence embeddings and the entity span embeddings further comprises:
upon determination that the entity span embeddings are within the dynamic prediction threshold, minimizing a second distance between the entity span embeddings and the first sentence embeddings; and
upon determination that the entity span embeddings are outside of the dynamic prediction threshold, maximizing a third distance between the entity span embeddings and the first sentence embeddings.

9. A non-transitory machine-readable medium, comprising executable instructions that, when executed by a processing system including a processor, facilitate performance of operations, the operations comprising:
receiving an entity description including an entity type special token at an entity type encoder;
receiving automatic speech recognition (ASR) transcription at a text encoder, wherein the ASR transcription further comprises an ASR special token, an ASR non-entity span and an ASR entity span;
receiving a manual transcription including a manual special token and a manual entity span at the text encoder;
generating first embeddings of the entity type special token in a common vector space;
generating second embeddings of the ASR special token, the ASR non-entity span and the ASR entity span in the common vector space;
generating third embeddings of the manual special token in the common vector space;
adjusting a first distance of the second embeddings of the ASR special token from the third embeddings of the manual special token; and
generating a predicted entity output and a predicted non-entity output based on the first embeddings of the entity type special token and the second embeddings of ASR special token, the ASR non-entity span and the ASR entity span.

10. The non-transitory machine-readable medium of claim 9, wherein the adjusting the first distance further comprises minimizing the first distance between the second embeddings of the ASR special token and the third embeddings of the manual special token.

11. The non-transitory machine-readable medium of claim 9, wherein the operations further comprise:
generating fourth embeddings of a manual entity span from the manual transcription; and
adjusting a second distance between the second embeddings of the ASR entity span from the fourth embeddings of the manual entity span via a cosine loss.

12. The non-transitory machine-readable medium of claim 9, wherein the operations further comprise training the text encoder based on both the ASR transcription and the manual transcription substantially simultaneously.

13. The non-transitory machine-readable medium of claim 9, wherein the operations further comprise:
determining a third distance between the first embeddings of the entity type special token and the second embeddings of the ASR special token;
setting a dynamic prediction threshold based on the third distance; and
with reference to the dynamic prediction threshold, determining each distance between the second embeddings of the ASR non-entity span and the first embeddings of the entity type special token and between the second embeddings of the ASR entity span and the first embeddings of the entity type special token.

14. A method, comprising:
receiving, by a processing system including a processor, a manual transcription at a text encoder;
receiving, by the processing system, an automatic speech recognition (ASR) transcription at the text encoder;
receiving, by the processing system, an entity type description at an entity type encoder;
generating, by the processing system, a natural language processing model by training the text encoder to learn from both the manual transcription and the ASR transcription, wherein the training comprises:
setting a reference point based on embeddings of the entity type description;
using a triplet loss function, maximizing a distance between the reference point and embeddings of an ASR non-entity span and minimizing a distance between the reference point and embeddings of an ASR entity span;
using a cosine loss, minimizing a distance between sentence embeddings of the ASR transcription and sentence embeddings of the manual transcription; and
using the cosine loss, minimizing a distance between embeddings of an ASR entity span and embeddings of a manual entity span; and
generating a predicted entity output and a predicted non-entity output using the trained natural language processing model.

15. The method of claim 14, comprising:
during an inference phase, receiving, by the processing system, an ASR utterance; and
in response to the ASR utterance, generating, by the processing system, a resulting predicted entity output and a resulting predicted non-entity output using the trained natural language processing model.

16. The method of claim 14, comprising:
tying, by the processing system, the sentence embeddings of the ASR transcription and the sentence embeddings of the manual transcription in a common vector space; and
tying, by the processing system, the embeddings of the ASR entity span and the embeddings of the manual entity span in the common vector space.

17. The method of claim 16, comprising:
executing, by the processing system, a span matching algorithm that maps equivalent entity spans in the ASR transcription and the manual transcription for training.

18. The method of claim 14, wherein the training further comprises:
receiving, by the processing system, a manually annotated text;
receiving, by the processing system, a corresponding ASR text; and
outputting, by the processing system, a set of input including manual entity spans, ASR entity spans and manual-ASR-entity matchings.

19. The method of claim 18, wherein the manual entity spans indicate which tokens in the manually annotated text are entities and entity types thereof, the ASR entity spans indicate which tokens in the ASR text are entities and entity types thereof, and the manual-ASR-entity matchings correspond to a set of one-to-one matchings between the manual entity spans in the manually annotated text and the ASR entity spans in the corresponding ASR text.

20. The method of claim 14, comprising:
determining a dynamic prediction threshold based on a distance from the embeddings of a special token associated with the entity type description to the embeddings of a special token associated with the ASR transcription, wherein the embeddings of the ASR non-entity span are positioned outside of the dynamic prediction threshold and the embeddings of the ASR entity span are positioned within the dynamic prediction threshold in a same vector space.
